(19) United States
(12) Patent Application Publication
(10) Pub. No.: US 2010/0149981 A1
(43) Pub. Date: Jun. 17, 2010

(54) Determining Normal Call Blocking Volume From Call Blast Affecting Trunk Groups

(75) Inventors: David L. Kimble, Danville, CA (US); Richard E. Burke, JR., Vacaville, CA (US)

Correspondence Address: AT&T Legal Department - CC;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/333,563

(22) Filed: Dec. 12, 2008

(51) Int. Cl. G08C 15/00

(52) U.S. Cl. 370/235

(57) ABSTRACT

A method is provided for utilizing a call block analysis tool of a computer system to determine the number of normal calls blocked on a telecommunication trunk group during a call blast event. After a call blast event has been determined to have occurred during a trunk group's calling hour, the method uses current and history trunk group traffic statistics to determine the number of “normal” calls that were blocked during a calling hour. This method uses historical average holding time, current offered load, current blocking proportions as well as current and historical peakedness to numerically solute for the number of “normal” calls blocked.

### BACKGROUND

Exemplary embodiments relate generally to communications, and more particularly, to blocked calls on trunking groups caused by a call blast event.

Modem telecommunication networks include many different types of technologies. Internet Protocol networks represent one type of network where IP packets are transmitted across the network. The public switched telephone network (PSTN) represents most widely used telephone network and was developed starting with Alexander G. Bell. Networks may also combine different types of technology. For example, a voice over the newer IP network (VOIP) carries voice calls in packet form, whereas the PSTN uses time division multiplexing (TDM), and can be thought of as virtual circuits being created between the calling and the called parties.

In order to connect users across the PSTN network, different facilities called trunks are used to connect switches. Trunks are used to carry calls between the calling and the called parties each being assigned a virtual circuit on the trunk group called a trunk or DS0. Many calls or data information can be transmitted on a trunk group up to the trunk group capacity. The trunk group capacity is the number of virtual circuits called number DS0. This capacity is managed to maximize efficiency by balancing the utilization against the blocking proportion at the trunk group's busiest hour (busy hour, BH).

Other non-PSTN networks often interface with the PSTN network through trunk groups, which may be the TDM trunks on the PSTN. These trunk groups may be, e.g., DS1, PR1, and DS3.

A “trunk” is a Digital Signal 0 (DS0) or any other example of a virtual connector between switches. DS0 is a basic digital signaling rate of 64 kilobits/second (kbit/s), corresponding to the capacity of one voice-frequency-equivalent channel. The DS0 rate forms the basis for the digital multiplex transmission hierarchy DS0. The purpose of the trunk may, for example, be to transmit a voice call between switching centers.

A call blaster event is when a single caller initiates many calls to called parties in a short period of time. This call blaster event maybe a school district using an autodialer to call their student's parents advising them that the district's school will be closed this morning due the over night's snow fall. This calling blast may occur in a few minutes to thousands and if the school district spans several PSTN switches, then the trunk groups connecting the caller's switch and the called parties' switch may be overwhelmed. As a relatively new issue, the school district call blast event overwhelming the connecting trunk groups will cause call blocking on that trunk group. A call blast event from an autodialer may overwhelm even a large sized, low utilization trunk group. Unlike regular voice, person to another person, calls which can be forecasted for each trunk group based on that trunk group's calling volume history, these call blaster calls are appear random and episodic so they can not forecasted from historical calling data. This large call volume of these bulk arrival events result in blocked calls. Most of the blocked calls usually are autodialer-initiated calls or similar bulk arrival generated calls, but other calls are non-bulk arrivals calls. This disclosure defines these other calls as “normal” calls.

A call blast event may negatively impact a trunk group during the call blast event. It would be beneficial to assess the impact of normal calls during a call blast event.

### BRIEF SUMMARY

Exemplary embodiments include a method for utilizing a call block analysis tool of a computer system to determine a number of normal calls blocked on a telecommunication trunk group during a call blast event, where the telecommunication trunk group operatively connects switches for facilitating communications. A call block analysis tool of a computer system monitors communication traffic of calls on a trunk group, wherein the trunk group comprises a plurality of communication paths from one switch to another switch. The tool recognizes that a peakedness exceeds a predetermined threshold for the trunk group. In response to the peakedness on the trunk group exceeding the predetermined threshold, the tool determines a call blocking duration which is a time period in which a call blast event causes calls to be blocked on the trunk group. The tool outputs an estimated number of normal calls blocked on the trunk group during the call blast duration.

Other systems, methods, apparatus, and/or computer program products according to embodiments will be or become apparent to one with skill in the art upon review of the following drawings and detailed description. It is intended that all such additional systems, methods, apparatus, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 illustrates a system in accordance with exemplary embodiments;

FIG. 2 illustrates a call blast busy hour Venn diagraph in accordance with exemplary embodiments;

FIG. 3 illustrates a graph of simulated measured loads in accordance with exemplary embodiments;

FIG. 4 illustrates the graph of FIG. 3 but with certain measured loads equal to the trunk group size;

FIG. 5 illustrates a graph which plots the offered load variance in accordance with exemplary embodiments;

FIG. 6 illustrates a method for determining a number of normal calls blocked on a trunk group during a call blast event in accordance with exemplary embodiments; and

FIG. 7 illustrates an example of a computer having elements that may be used in implementing exemplary embodiments in accordance with exemplary embodiments.

The detailed description explains the exemplary embodiments, together with features, by way of example with reference to the drawings.

### DETAILED DESCRIPTION OF EXEMPLARY EMBODIMENTS

Exemplary embodiments provide a tool which assesses the impact of trunk group blocking on normal calls during a call blast event. Normal calls are defined as calls not initiated by the call blast event. That is, calls that would have been initiated even if the call blaster event had not occurred, such as someone calling home from the office, or a human being calling other human being. This tool adds an important assessment in determining the impact of the call blast event on these “normal” calls, and can be used to support trunking administrators' decisions not to augment low utilization trunk groups or to augment low utilization trunk groups.

In accordance with exemplary embodiments, this tool's algorithm estimates normal call blocking using several steps. The tool may estimate the call blocking duration within the test hour using peakedness, the offered load, the average holding time, and simulated intra-busy hour traffic. Next, the tool may calculate the calling during the non-caller blaster event time as well as during the call blast time. Also, the tool solves for the number of calls blocked using the busy hour blocking proportion. The probability of blocking calls during the “call blocking duration” leads to the estimated number of normal calls blocked.

Further, the tool can allow trunking administrators (such as AT&T trunking administrators) to provide objectively-derived call blast event impact on normal callers. This impact may not be great, as estimated by this tool, in which case the trunking administrators can use this low impact estimate as further evidence that a state's 271 trunk blocking penalties should not be levied against a telecommunication provider. The impact on normal callers can be used by the trunking administrators who need to assess the blocking impact on their company's trunk groups.

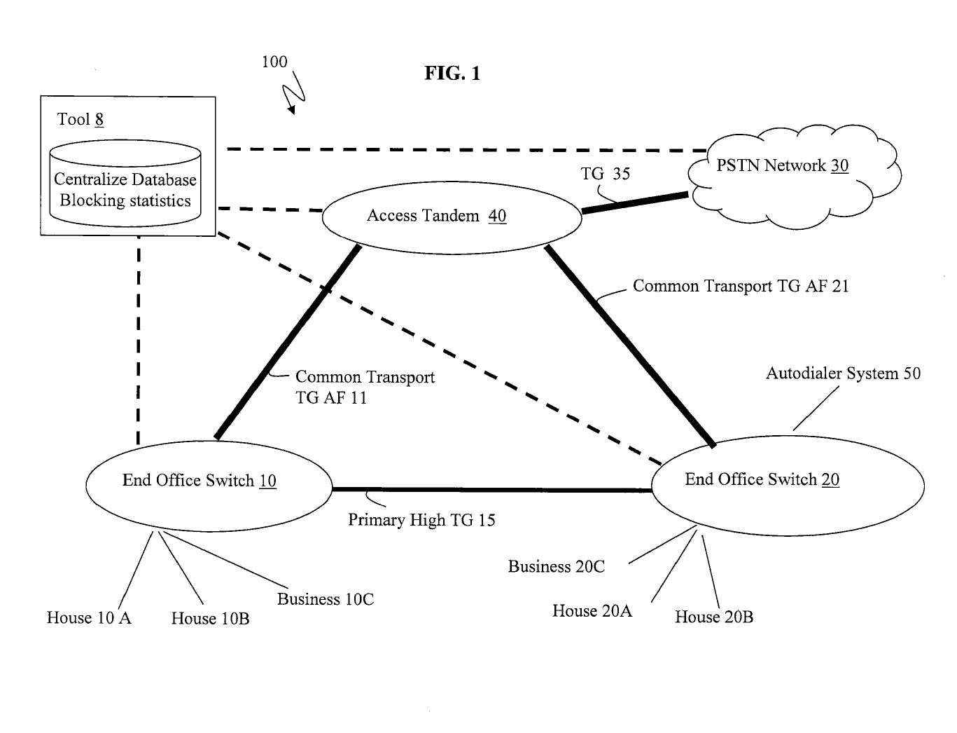

FIG. 1 illustrates a system 100 in accordance with exemplary embodiments. FIG. 1 shows the simple TDM network with an access tandem (AT) 40 and two end office (EO) TDM switches 10 and 20. The system 100 illustrates the EO TDM switch 10 operatively connected to the EO TDM switch 20 via primary high trunk group TG 15.

The EO switches 10 and 20 include all the necessary communication hardware and software to function and operate as switches for telecommunications. The EO switches 10 and 20 may represent two telephone exchanges, which can include subscriber lines connected to the EO switches 10 and 20, trunk groups connecting to other switches, switching matrices within these switches, computer processor units (CPU), and remote hubs. For example, houses 10A, houses 10B, and business 10C may be operatively connected to the EO switch 10. Also, houses 20A, houses 20B, business 20C, and an autodialer system 50 may be operatively connected to the EO switch 20. The houses and businesses are representative of a plurality of entities.

The access tandem (AT) 40 is operatively connected to the EO switch 10 via a common transport trunk group (TG) 11, and the AT 40 is operatively connected to the EO switch 20 via a common transport trunk group (TG) 21. The AT 40 is operatively connected to a PSTN network 30 via a trunk group (TG) 35.

The trunk group (TG) 15 may consist of many trunks, which connect the EO switches 10 and 20. The TG 15 may use SS7 or multifrequency signaling for trunk set up. A single trunk group, e.g., may contain 24 trunks or multiples of 24 trunks. Each trunk group 15 may consist of Digital Signal 0 (DS0s) from different circuits, but each individual DS0 may belong to only one trunk group. Digital Signal 0 (DS0) is a basic digital signaling rate of 64 kilobits/second, corresponding to the capacity of one voice-frequency-equivalent channel.

The end office switches 10 and 20 use local databases to determine which trunk group that each dialed call belongs to and use central databases for call set up and ported number look up. Also, the traffic statistics such as offered load, call attempts, and calls blocks by calling hour are stored in centralized databases. These statistics are used to maintain and engineer the switches as well as the trunk groups 11, 15, 21, and 35. Using this stored historical and current statistics, a Tool 8 can estimate the “normal” calls blocked in accordance with exemplary embodiments. Also, Tool 8 may reside at this central location, such as in a centralized traffic control system. The blocking and other TG statistics may be stored centrally, e.g., with the Tool 8 or at a remote location.

A centralized traffic control system may be configured to monitor the switches 10 and 20 and the trunk groups (TG) 11, 15, 21, and 35, as well as all the other switches and trunks in the PSTN network 30. Accordingly, the centralized control system is capable of reporting call volumes as well as blocking events. The historical data stored in centralized databases may include the offered load (traffic), available trunks, blocked calls, attempted calls, and calls completed, etc.

The autodialer system 50 is configured to call many parties from one caller. For the sake of presentation the following is an example of an autodialer event. A school district uses the autodialer 50 to call its student's houses served by switches 10 and 20. This means the students served by switch 10 will receive calls carried by trunk group 15 from the autodialer 50 served by switch 20. The call block analysis Tool 8 is configured to estimate the number of normal calls blocked during this call blast event in accordance with exemplary embodiments. The call block analysis Tool 8 may be implemented as computer executable instructions (e.g., applications, code, modules, etc.) or application specific integrated circuits. Also, the description provided for the call block analysis Tool 8 can be applied to the trunk group of the entire network.

With regard to the trunk group TG 15, the call block analysis Tool 8 may be configured to monitor, measure, extract, calculate, and determine quantities that may be needed to determine the number of normal calls blocked during a call blast event in accordance with exemplary embodiments.

Exemplary embodiments can determine blocking as a function of utilization and episodic peakedness. The call block analysis Tool 8 can use historical data and measured/monitored data of the trunk group (TG) 15 to determine the normal calls blocked during a call blast event. For example, if a low utilization trunk group (TG) 15 has a history of peakedness coefficient equal to 1 and no blocking, and then the trunk group TG 15 has call blocking with a high peakedness coefficient, the call blocking analysis Tool 8 (or administrator) may recognize that call blocking is occurring (or has occurred). The Tool 8 may use the historical utilization and historical peakedness of a particular trunk to estimate the number of “normal” calls blocked during a call blaster event.

The call block analysis Tool 8 may estimate (or measure) the call blocking duration (CBD) of the trunk group 15. The call blocking duration is the duration (time period) within that event's calling hour that the call blast event causes some calls to be blocked.

The call block analysis Tool 8 can determine the total number of calls blocked during the call blocking duration by monitoring the trunk group TG 15. The call block analysis Tool 8 may monitor and record the number of calls that attempted (desired) to use the trunk group 15 but were unable (blocked). Also, the call block analysis Tool 8 can calculate the number of calls blocked during the call blocking duration based on the calls attempted and the completed calls which were able to utilize the trunk group TG 15. Also, the call block analysis Tool 8 can parse the historical data corresponding to the call blocking duration to determine the number of calls blocked during that time. If call blocking is greater that 0, then at some time during the calling (busy) hour all the trunk group's DS0s were busy when new calls arrived.

The peakedness is calculated for each calling hour as the statistical variance of the offered load (which is the particular hour being analyzed) divided by the average offered load (the average offered load may be obtained from historical data) during that calling hour. The trunk group's peakedness will often increase (greatly) when a blast event occurs. So when the peakedness exceeds the historically determined threshold, the call block analysis Tool 8 may determine (estimate) the call blocking duration for the trunk group in exemplary embodiments. For example, if TG 15 has a historical peakedness of 1.0 and during an hour increases to 20.0 (along with other traffic statistics), it may be recognized that call blocking likely occurred (e.g., a call blaster event caused by the autodialer 50) in exemplary embodiments.

The average holding time for normal calling can be determined by the call block analysis Tool 8 from historical data of holding times for normal calls on the trunk group TG 15 when there is not a call blast event. The historical offered load for normal calling can be calculated by the call block analysis Tool 8 based on historical data of the average offered load during for normal calls when there is not a call blast event on the trunk group TG 15. The offered load for historical normal calling may be the median offered load.

The call block analysis Tool 8 can determine the total call volume during the call blast duration. The call block analysis Tool 8 can monitor and record the total call volume over the trunk group TG 15. Also, the call block analysis Tool 8 can parse historical data for the trunk group TG 15 to determine the total call volume for the time of the call blast duration on the trunk group TG 15.

The call blocking analysis Tool 8 can determine the proportion of a call (any calls) blocked during the call blocking duration, by dividing the total number of calls blocked during the call blocking duration by the total call volume during the call blocking duration. The proportion of calls blocked during the call blocking duration may be considered the probability of calls blocked during the call blocking duration.

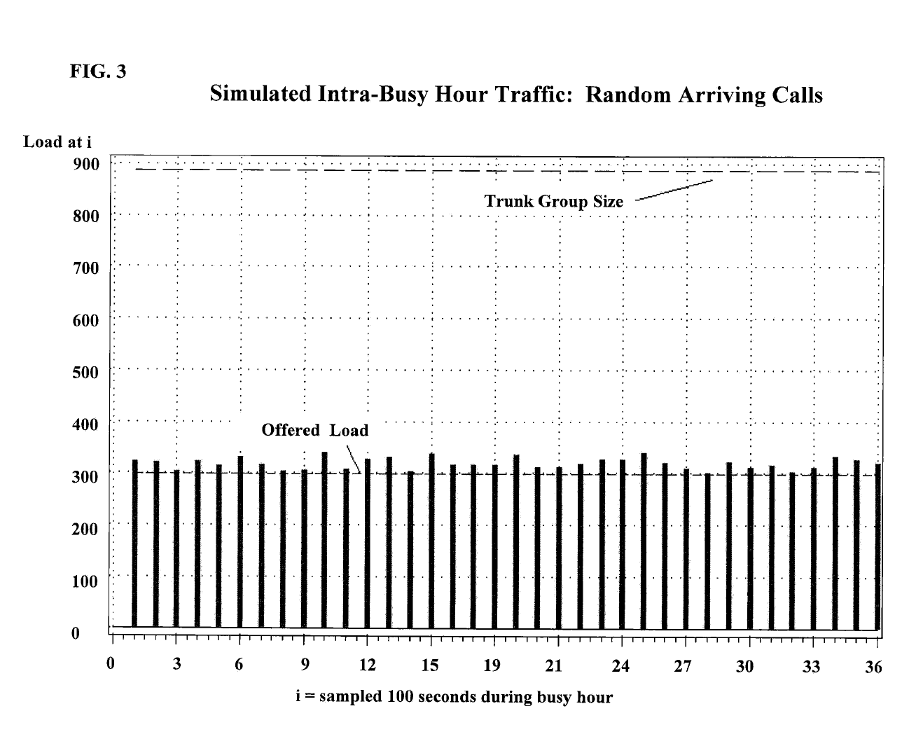

The call blocking analysis Tool 8 can calculate the maximum number of normal calls blocked, by multiplying the number of normal calls arriving during the call blocking duration (which is the normal calling volume) times the probability a call is blocked during the calling period. This maximum estimate is upper bound and is likely to be an over-estimate of normal calls blocked in some situation. So the Tool 8 can produce a second more realistic estimate of normal calls blocked as discussed herein with reference to an example in FIG. 3 in accordance with exemplary embodiments.

Call blocking analysis Tool 8 uses the following to estimate the number of normal calls blocked:

Number of normal calls blocked=Number of normal calls arriving during call blocking period*probability a call is blocked during the call blocking period.

This approach requires calculating three quantities.

Table 1 having quantities that may be used in calculating the number of normal calls blocked according to exemplary embodiments is illustrated below. For explanatory purposes, an example simulation will be discussed in which exemplary embodiments were implemented, and it is understood that exemplary embodiments are meant to be limited to the illustrations of the simulation.

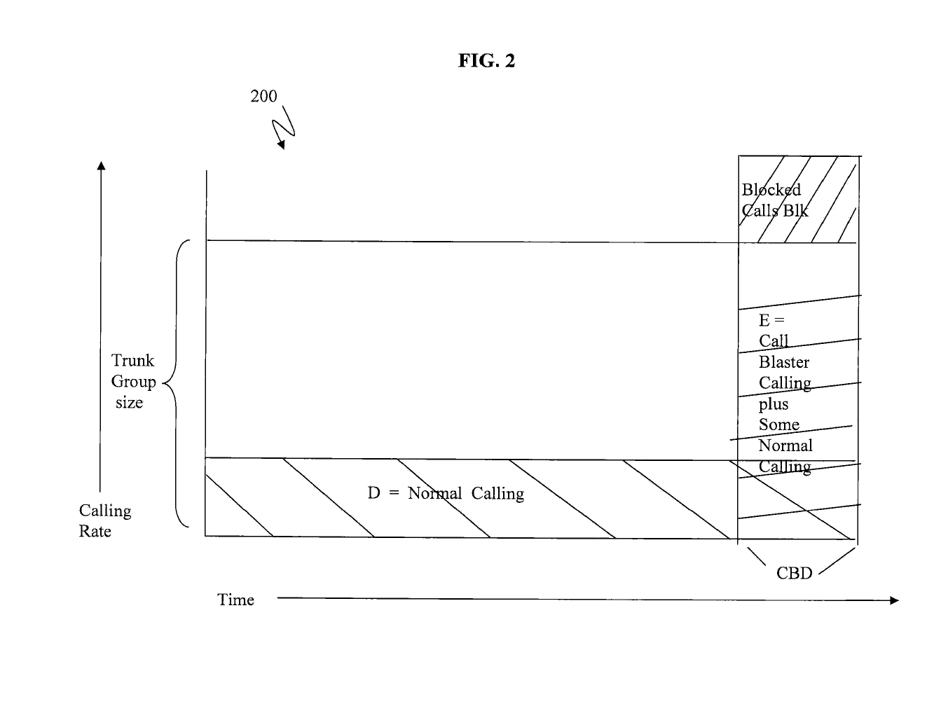

TABLE 1

| Quantities | Secondary quantity needed | Modeling method used |
|---|---|---|
| 1. Duration of blocking period | Number of intra-TCBH periods | Simulation of intra-calling |
| CBD | where blocking occurred. | normal offered load with extreme |
| | | loads equal to trunk group size at |
| | | some periods; Compared call |
| | | blast peakedness to simulated |
| 2. Number of normal call | Area of D∩E | Using Little's Result and the |
| attempts during the blocking | See FIG. 2 | normal offered load, we can solve |
| period | | for the average normal period call |
| | | arrival rate. Using this rate and |
| | | the blocking duration, the normal |
| | | call attempts can be estimated. |
| 3. Blocking probability of any | Areas of D, D∪E, D∩E, E, | This is an average relative |
| call during blocking period | and “Blk” | frequency blocking approach. |
| $P ( {B}_{2} ) = \frac{Blk}{{E}^{′}}$ | | |
| 3A. Blocking probability of any | Instantaneous offered load during | Erlang B for the blocked periods. |
| call during blocking period. | blocking period | |
| P(B_{2A}) = Erlang B | | |
| at offered load E′ | | |
| 4. Number normal calls blocked | | |
| N₂ = P(B₂)*(D∩E) | | |

FIG. 2 presents a call blast busy hour Venn diagraph 300 in accordance with exemplary embodiments. In the Venn diagraph 300 where the calling rate (calls per second) is on the vertical axis and time (seconds) is on the horizontal axis. The area “D” represents the normal calling, the area “E” represents the call blast calling, and the area “Blk” represents the calls blocked. “CBD” is the call blocking duration. The “TG size” is the trunk group size in DS0s. In the Venn diagraph 300, the call blocking duration is placed at the end of the time consistent busy hour (TCBH) for the drawing convenience. The analysis (implemented by the Tool 8) needs to estimate areas “D”, “E”, and “Blk” according to exemplary embodiments.

The Call Blocking Duration (CBD) within the time consistent busy hour (TCBH) is estimated. If the call blocking is greater than 0, then at some time during the TCBH all the trunk group's DS0 were busy when new calls arrived. These call attempts and blocked calls are actual counts made during the TCBH and not estimated at 100 second intervals like offered loads are estimated in FIG. 3. FIG. 3 graphs an illustrative example of simulated measured loads during the intra-TCBH with the median historical time series offered load as the average offered load.

The peakedness is a secondary statistic estimated by 36 samples during the TCBH and is equal to the sample variance of the offered load divided by the average offered load. It should be noted that the 36 samples during the TCBH offered load can exceed the trunk group size, while true offered load can. To distinguish these offered load differences, this disclosure calls the 36 period offered loads “measured loads”.

Using these blocking concepts and peakedness concepts, the analysis (in which the Tool 8 is configured to implement) simulates each “call blast” TCBH trunk group intra-TCBH 36 sampling periods using the “normal” calling average offered load in a Poisson model as shown in FIG. 3.

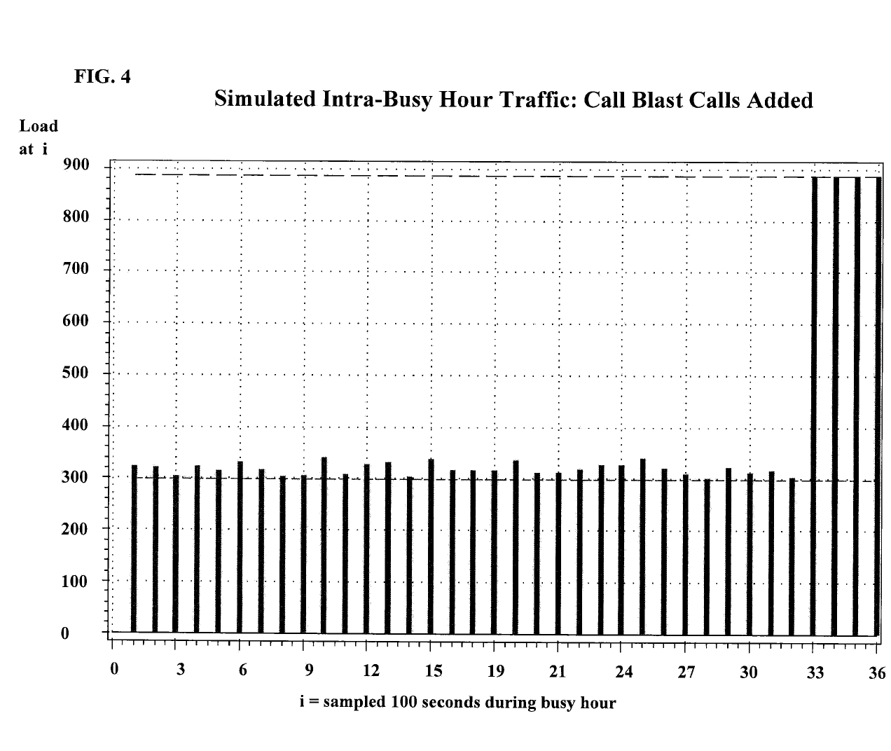

FIG. 4 illustrates the same graph as shows in FIG. 3 but with 4 intra-TCBH time period measured loads equal to the trunk group size. The next step in this simulation example is to repeat the simulation, but in this run setting one of the 36 intra-TCBH period's measured loads equal to the trunk group size and recalculating the peakedness from the 36 measured load's average and variance. This step is repeated for 2, 3, 4 and 5 intra-TCBH periods having the measured load set equal to the trunk group size. These simulated peakednesses are then compared the call blast peakedness. The two simulations whose peakednesses bound the call blast peakedness also bound the blocking time period. Using extrapolation, the call blocking duration (CBD) is estimated.

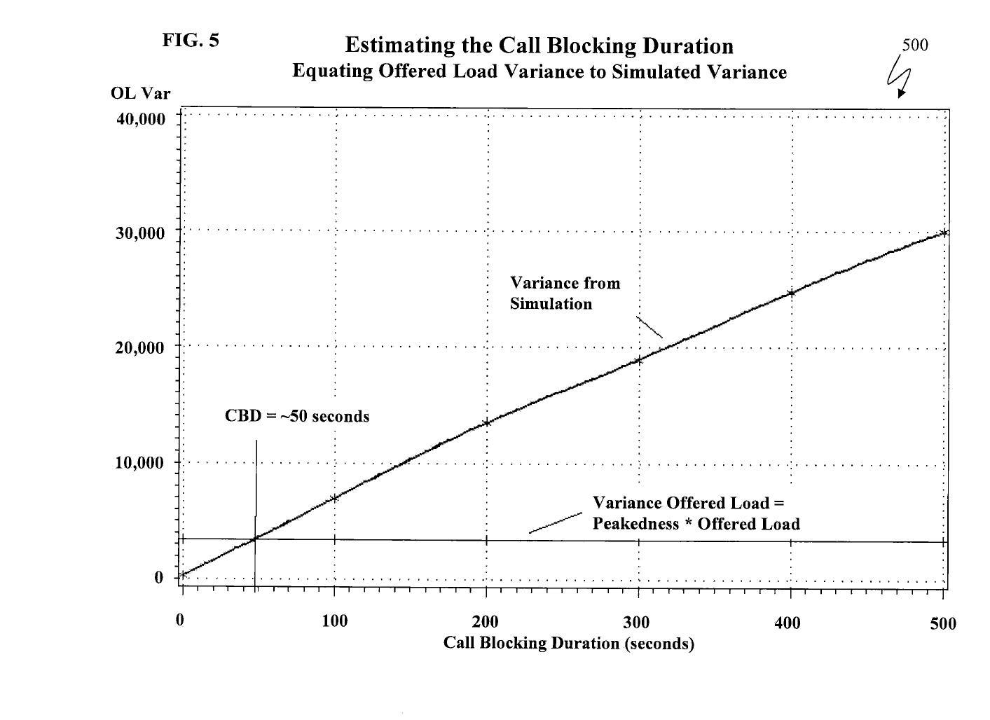

FIG. 5 illustrates a graph 500 which plots the intra-TCBH offered load variance of both the simulated offered load (see FIG. 4) and the actual offered load variance against Call Blocking Duration. This graph is an illustrated example using trunk group AB700683. In the graph 500, the solution CBD is approximately 50 seconds, and the solution is where actual historical published offered load is equal to the simulated intra-TCBH variance. The simulated intra-TCBH offered load variance is nearly linear.

In accordance with exemplary embodiments, “D” (the Normal Call Volume) is estimated. Using Little's Results (which is a simulation program), the normal call volume is:

$$\begin{matrix}“ D ” = Normal Calling Volume \\ = \frac{offered Load Normal calling}{Average holding time normal calling} * 3600\end{matrix}$$

Using median historical offered load and average holding times for the normal calling, this “D” can be calculated.

In accordance with exemplary embodiments, “E” (Total Calls During the Call Blast Duration) is estimated. The total calling during the TCBH hour is the union of areas D and E “(D ∪ E)”.

Yet once again using the Little's Results, the normal call volume is:

$$Call Blast TCBH Calling Volume = “ D ⋃ E ” = \frac{Call Blast Offered Load calling}{Call Blast Average holding calling} * 3600$$

(Little's Result is well know in Queueing Theory and is: Average_Offered_Load=Average_hold_time*Average_Calling_arrival_rate)

Using the call blast historical offered load and average holding times, the “(D ∪ E)” can be calculated.

The intersected of areas D and E=(D ∩ E) would be the normal TCBH call attempt rate times the call blocking duration.

$$D ⋂ E = \frac{offered Load Normal calling}{Average holding time normal calling} * CBD$$

So the call volume during the calling blocking period would be

E′=D∪E−D+D∩E

Because of the measured load versus the true offered load issue discussed earlier, a more corrected estimate of all call attempts during the call blocking period would be:

E′=D∪E−D+D∩E+Blk

Now, “Blk” (Calls Blocked during the Call Blocking Duration) is estimated. Knowing the blocking formula for the entire TCBH, we have the following:

$$P ( B ) = \frac{All calls blocked during TCBH}{All calls attempted during TCBH}$$

so

All calls blocked during TCBH=P(B)*All calls attempted during TCBH

Using the published call blast historical statistics, the TCBH average holding and offered load are known. (It is noted that the true offered load will be greater than the historical published one because of the truncated count during the blocking period.) Again using Little's Result, the (total) number of blocked calls is:

$$P ( B ) = \frac{Blk}{( D ⋃ E ) + Blk}$$

$$Blk = \frac{( D ⋃ E ) * P ( B )}{1 - P ( B )}$$

Next, the probability of blocking (any calls) during the call blocking duration is provided according to exemplary embodiments. Assuming all these blocked calls during the TCBH happened during the call blast blocking period and knowing the normal call attempts, then

$$\begin{matrix}P ( {B}_{2} ) = P ( Blocking during CBD ) \\ = \frac{Blk}{{E}^{′}}\end{matrix}$$

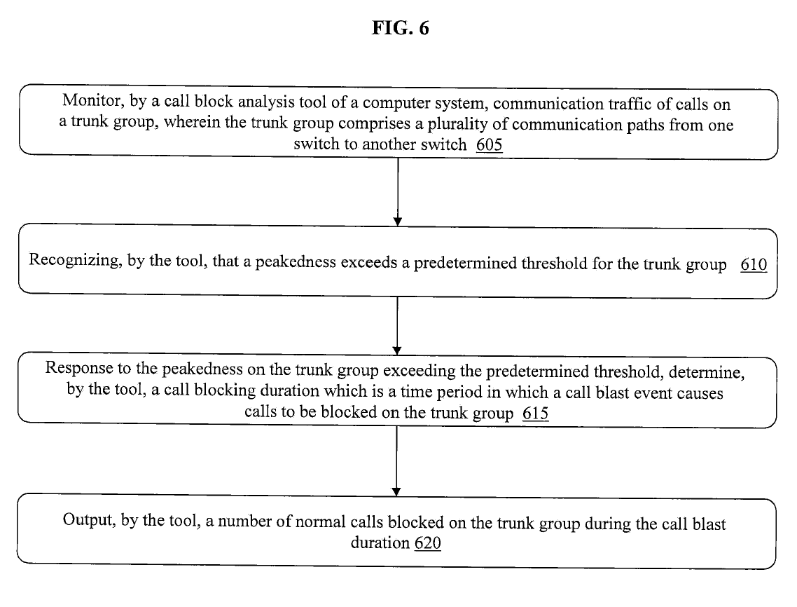

FIG. 6 illustrates a method for utilizing a call block analysis tool of a computer system for determining a number of normal calls blocked on a telecommunication trunk group during a call blast event in accordance with exemplary embodiments.

The call block analysis Tool 8 may monitor communication traffic on a trunk group where the trunk group comprises a plurality of communication paths from one switch to another switch at 605.

The Tool 8 is configured to recognize that a peakedness exceeds a predetermined threshold for the trunk group at 610.

In response to the peakedness on the trunk group exceeding the predetermined threshold, the Tool 8 determines a call blocking duration which is a time period in which a call blast event causes calls to be blocked on the trunk group at 615.

The Tool 8 outputs (an estimated) number of normal calls blocked on the trunk group during the call blast duration from procedure defined above at 620.

The estimated number of normal calls blocked may be determined by deriving the call blocking duration proportion of a call blocking hour, estimating a number of normal calls attempted during the call blocking duration, estimating the proportion of all calls blocked during the call blocking duration, and multiplying the proportion of all calls blocked during the call blocking duration times the number of normal calls attempted during the during the call blocking duration.

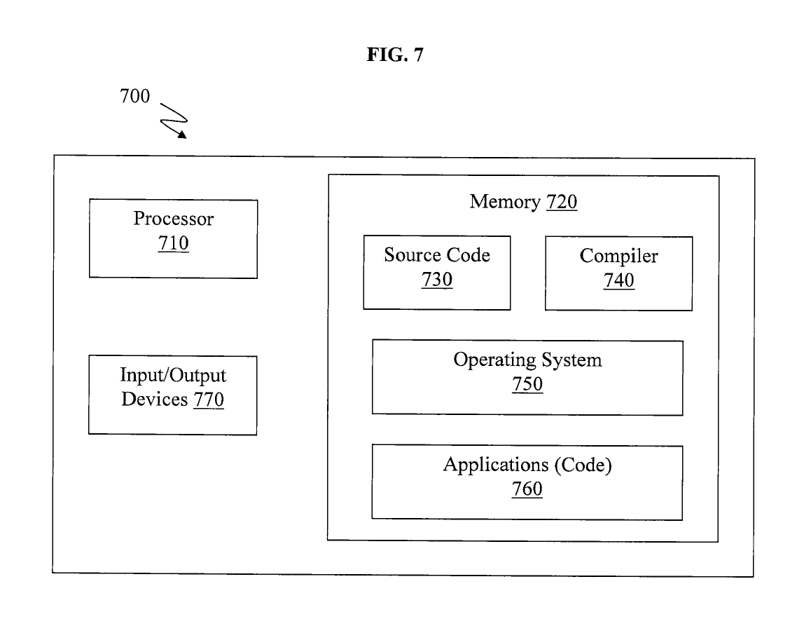

It is appreciated that the Tool 8 and other features of exemplary embodiments may be implemented by modules, applications, programs, etc., of a computing device. By way of example but not limitation, FIG. 7 illustrates an example of a computer 700 having elements that may be used in implementing exemplary embodiments. The computer 700 includes, but is not limited to, PCs, workstations, systems, laptops, PDAs, palm devices, servers, mobile devices, communication devices, cell phones, and the like. The computer 700 may include a processor 710, memory 720, and one or more input and/or output (I/O) 770 devices (or peripherals) that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 710 is a hardware device for executing software that can be stored in the memory 720. The processor 710 can be virtually any custom made or commercially available processor, a central processing unit (CPU), a data signal processor (DSP), or an auxiliary processor among several processors associated with the computer 700, and the processor 710 may be a semiconductor based microprocessor (in the form of a microchip) or a macroprocessor.

The memory 720 can include any one or combination of volatile memory elements (e.g., random access memory (RAM, such as dynamic random access memory (DRAM), static random access memory (SRAM), etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 720 may incorporate electronic, magnetic, optical, and/or other types of storage media. Note that the memory 720 can have a distributed architecture, where various components are situated remote from one another, but can be accessed by the processor 710.

The software in the memory 720 may include one or more separate programs, each of which comprises an ordered listing of executable instructions for implementing logical functions. In the example illustrated in FIG. 7, the software in the memory 720 includes a suitable operating system (O/S) 750, compiler 740, source code 730, and one or more an application 760 (or modules) of the exemplary embodiments.

The operating system 750 controls the execution of other computer programs, and provides scheduling, input-output control, file and data management, memory management, and communication control and related services. It is contemplated by the inventors that the application 760 for implementing exemplary embodiments is applicable on all other commercially available operating systems.

The application 760 may be a source program, executable program (object code), script, or any other entity comprising a set of instructions to be performed. When a source program is to be executed, then the program is usually translated via a compiler (such as the compiler 740), assembler, interpreter, or the like, which may or may not be included within the memory 720, so as to operate properly in connection with the O/S 750. Furthermore, the application 760 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices 770 may include input devices such as, for example but not limited to, a mouse, keyboard, scanner, microphone, biometric input device(s), etc. Furthermore, the I/O devices 770 may also include output devices, for example but not limited to, a printer, display, etc. Also, the I/O devices 770 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 770 include may include modems, gateways, receivers, transmitters, transceivers, etc. for communicating over a communications network.

When the computer 700 is in operation, the processor 710 is configured to execute software stored within the memory 720, to communicate data to and from the memory 720, and to generally control operations of the computer 700 pursuant to the software. The application 760 and the O/S 750 are read, in whole or in part, by the processor 710, perhaps buffered within the processor 710, and then executed.

When the application 760 is implemented in software, it should be noted that the application 760 can be stored on virtually any computer readable medium for use by or in connection with any computer related system or method. In the context of this document, a computer readable medium may be an electronic, magnetic, optical, or other physical device or means that can contain or store a computer program for use by or in connection with a computer related system or method.

The application 760 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, computer programs tangibly embodied on a computer-readable medium can be stored, communicated, propagated, or transported for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In exemplary embodiments, where the application 760 is implemented in hardware, the application 760 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

As described above, the exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be in the form of computer program code, for example, whether stored in a storage medium, loaded into and/or executed by a computer. When the computer program code is loaded into an executed by a computer, the computer becomes an apparatus for practicing the exemplary embodiments. When implemented on a general-purpose microprocessor, the computer program code segments configure the microprocessor to create specific logic circuits. It is understood that computer program code can be transmitted over some transmission medium, loaded into and/or executed by a computer, or transmitted over some transmission medium, such as over electrical wiring or cabling, through fiber optics, or via electromagnetic radiation.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for utilizing a call block analysis tool of a computer system for determining a number of normal calls blocked on a telecommunication trunk group during a call blast event, where the telecommunication trunk group operatively connects switches for facilitating communications, the method comprising:
monitoring, by a call block analysis tool of a computer system, communication traffic of calls on a trunk group, wherein the trunk group comprises a plurality of communication paths from one switch to another switch;
recognizing, by the tool, that a peakedness exceeds a predetermined threshold for the trunk group;
in response to the peakedness on the trunk group exceeding the predetermined threshold, determining, by the tool, a call blocking duration which is a time period in which a call blast event causes calls to be blocked on the trunk group; and
outputting, by the tool, an estimated number of normal calls blocked on the trunk group during the call blast duration.

2. The method of claim 1, further comprising determining, by the tool, the total number of normal calls arriving at the trunk group during the call blocking duration.

3. The method of claim 1, further comprising calculating, by the tool, the probability any call is blocked during the call blocking duration.

4. The method of claim 1, further comprising determining the estimated number of normal calls blocked by:
deriving the call blocking duration proportion of a call blocking hour;
estimating a number of normal calls attempted during the call blocking duration;
estimating a proportion of all calls blocked during the call blocking duration; and
multiplying the proportion of all calls blocked during the call blocking duration times the number of normal calls attempted during the during the call blocking duration.

5. The method of claim 1, wherein determining the call blocking duration comprises determining when an offered load of the trunk group exceeds the capacity for the trunk group.

6. The method of claim 1, wherein the normal calls are non-blast event calls.

7. A computing apparatus for determining a number of normal calls blocked on a telecommunication trunk group during a call blast event, where the telecommunication trunk group operatively connects switches for facilitating communications comprising:
memory for storing a program for providing reverse auction services; and
a processor, functionally coupled to the memory, the processor being responsive to computer-executable instructions contained in the program and operative to:
monitor communication traffic of calls on a trunk group, wherein the trunk group comprises a plurality of communication paths from one switch to another switch;
recognize that a peakedness exceeds a predetermined threshold for the trunk group;
in response to the peakedness on the trunk group exceeding the predetermined threshold, determine a call blocking duration which is a time period in which a call blast event causes calls to be blocked on the trunk group; and
output an estimated number of normal calls blocked on the trunk group during the call blast duration.

8. The apparatus of claim 7, wherein the processor is operative to determine the total number of normal calls arriving at the trunk group during the call blocking duration.

9. The apparatus of claim 7, wherein the processor is operative to calculate the probability any call is blocked during the call blocking duration.

10. The apparatus of claim 7, wherein the processor is operative to determine the call blocking duration comprises determining when an offered load of the trunk group exceeds the capacity for the trunk group.

11. The apparatus of claim 7, wherein the normal calls are non-blast event calls.

12. The apparatus of claim 7, wherein the processor is operative to determine the estimated number of normal calls blocked by:
deriving the call blocking duration proportion of a call blocking hour;
estimating a number of normal calls attempted during the call blocking duration;
estimating a proportion of all calls blocked during the call blocking duration; and
multiplying the proportion of all calls blocked during the call blocking duration times the number of normal calls attempted during the during the call blocking duration.

13. A computer program product, tangibly embodied on a computer readable medium, the computer program product including instructions for causing a computer to execute a method for determining a number of normal calls blocked on a telecommunication trunk group during a call blast event, where the telecommunication trunk group operatively connects switches for facilitating communications, comprising:
monitoring communication traffic of calls on a trunk group, wherein the trunk group comprises a plurality of communication paths from one switch to another switch;
recognizing that a peakedness exceeds a predetermined threshold for the trunk group;
in response to the peakedness on the trunk group exceeding the predetermined threshold, determining a call blocking duration which is a time period in which a call blast event causes calls to be blocked on the trunk group; and
outputting a number of normal calls blocked on the trunk group during the call blast duration by.

14. The computer program product of claim 13, further comprising determining the total number of normal calls arriving at the trunk group during the call blocking duration.

15. The computer program product of claim 13, further comprising calculating the probability any call is blocked during the call blocking duration.

16. The computer program product of claim 13, wherein determining the call blocking duration comprises determining when an offered load of the trunk group exceeds the capacity for the trunk group.

17. The computer program product of claim 13, further comprising determining the estimated number of normal calls blocked by:
deriving the call blocking duration proportion of a call blocking hour;
estimating a number of normal calls attempted during the call blocking duration;
estimating a proportion of all calls blocked during the call blocking duration; and
multiplying the proportion of all calls blocked during the call blocking duration times the number of normal calls attempted during the during the call blocking duration.
